(19) United States
(12) Patent Application Publication
(10) Pub. No.: US 2009/0274884 A1
(43) Pub. Date: Nov. 5, 2009

(54) COLORED-IMAGE POSTER

(76) Inventor: Bruce Brachman, Springfield, PA (US)

Correspondence Address: AMSTER, ROTHSTEIN & EBENSTEIN LLP, 90 PARK AVENUE, NEW YORK, NY, 10016, US

(21) Appl. No.: 12/115,272

(22) Filed: May 5, 2008

(51) Int. Cl. B32B 29/00; B05D 5/10; B05D 1/16; B32B 3/02

(52) U.S. Cl. 428/211.1; 427/256; 427/462; 428/195.1

(57) ABSTRACT

A colored-image sheet including at least one surface. The at least one surface includes a first image having at least one color photographic image, and a second image having boundaries defined by elevated portions on the at least one surface. The second image is capable of receiving colored media.

### FIELD OF THE INVENTION

The present invention generally relates to modifiable colored images.

### BACKGROUND OF THE INVENTION

Coloring posters that include areas to be colored in outlined with elevated portions made of, for example, black velvet (i.e., flock) are known in the art. See, for example, U.S. Pat. Nos. 2,319,044 and 3,093,462. However, the process of forming the elevated portions limits the size, and thus the detail, of the images formed by the combination of the elevated portions and the portions to be colored in. Thus, prior coloring posters include relatively simplistic images, without the fine detail that may be more attractive and interesting to young children.

Accordingly, there is a need for a coloring poster that allows for the display of detailed imagery, while also providing the user with the ability to color in areas of the poster with the guidance of elevated portions.

### SUMMARY OF THE INVENTION

A colored-image sheet according to an exemplary embodiment of the present invention comprises: at least one surface comprising: a first image comprising at least one color photographic image; and a second image having boundaries defined by elevated portions on the at least one surface, the second image being capable of receiving colored media.

In at least one embodiment, the elevated portions are made of velvet, plastic or paper.

In at least one embodiment, the sheet is a poster.

In at least one embodiment, the sheet is a page of a book.

In at least one embodiment, the elevated portions are non-permeable to the colored media.

In at least one embodiment, the first and second images form portions of the same image.

In at least one embodiment, the colored-image sheet further comprises a mechanism for producing at least one of sound and light.

In at least one embodiment, the mechanism produces music.

In at least one embodiment, the colored-image sheet further comprises a coloring instrument holder attached to a portion of the colored-image sheet.

A method of making a colored-image sheet according to an exemplary embodiment of the present invention comprises the steps of: printing a color image on a base sheet, the color image comprising at least one full color photographic image and at least one black and white image; and attaching elevated portions to first portions of the at least one black and white image to define second portions within the at least one black and white image to be colored in.

In at least one embodiment, the step of attaching comprises printing glue onto the first portions of the at least one black and white image.

In at least one embodiment, the step of printing glue comprises a silk screen printing process.

In at least one embodiment, the step of attaching comprises attaching flock to the first portions of the at least one black and white image.

In at least one embodiment, the method further comprises the step of applying an electrostatic charge to at least one of the base sheet and the flock so as to force the flock to stand vertically on the base sheet.

### BRIEF DESCRIPTION OF THE DRAWINGS

The above and related objects, features and advantages of the present invention will be more fully understood by reference to the following, detailed description of the preferred, albeit illustrative, embodiment of the present invention when taken in conjunction with the accompanying figures, wherein:

FIG. 1 shows a colored-image poster according to an exemplary embodiment of the present invention;

FIG. 2 is a flowchart showing a method of forming a colored-image poster according to an exemplary embodiment of the present invention; and

FIG. 3 shows a colored-image poster according to an exemplary embodiment of the present invention including an additional element.

### DETAIL DESCRIPTION OF THE PREFERRED EMBODIMENT(S)

The present invention is directed to a colored-image poster that includes a first image made up of at least one color photographic image, and a second image defined by elevated portions. The second image is capable of receiving colored media. Thus, the colored-image poster according to the present invention is able to display detailed images, in addition to less detailed black and white images for later coloring.

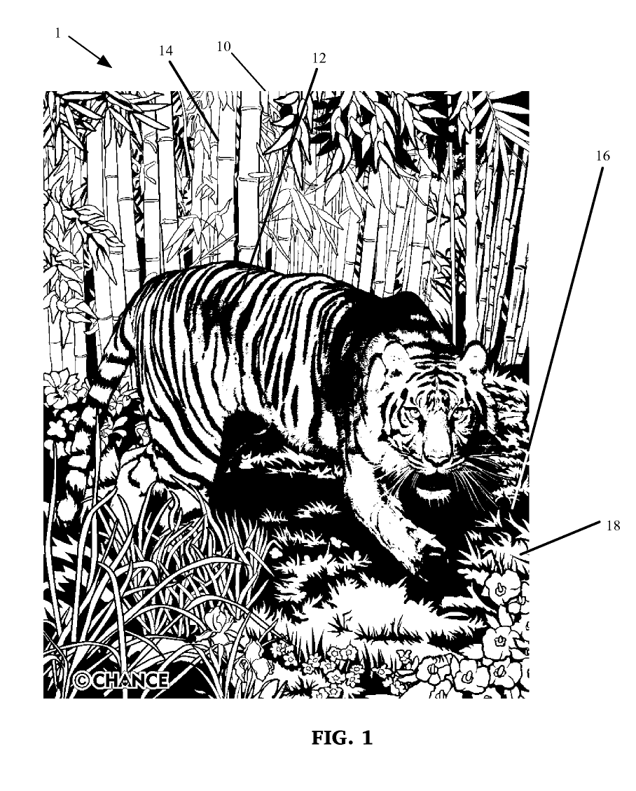

FIG. 1 shows a colored-image poster, generally designated by reference number 1, according to an exemplary embodiment of the present invention. The colored-image poster 1 may include a base sheet 10, and colored images 12 and black and white images 14 formed on the base sheet 10. The base sheet 10 may be made to any suitable size, such as sizes suitable for conventional book formats so that the sheet may be used as a page of a coloring book, for example. Further, the base sheet 10 may be made of any suitable material, such as, for example, paper or cardboard.

The colored images 12 may be formed on the base sheet 10 using any suitable technology, such as, for example, printing, scanning and copying. The colored images 12 are preferably colored photographic images, and may show highly detailed features of a comprehensive image formed by the combination of the colored images 12 and the black and white images 14. For example, the colored images 12 may be faces or facial features of people portrayed in the comprehensive image.

The black and white images 14 preferably include elevated portions 16 formed on the base sheet 10. The elevated portions 16 may define clear, or unobstructed, spaces 18 that may be colored by a user using colored media, such as, for example, colored pencil, paint and colored markers. In this regard, the base sheet 10 is preferably textured or otherwise structured so as to readily accept the colored media. The elevated portions 16 may obstruct portions of the base sheet 10 so that the portion may not be directly colored by a user. As a result, a user is influenced to color the unobstructed portions of the black and white images 14. A user coloring such unobstructed positions is physically forced to stay within the unobstructed portions because when a coloring instrument attempts to go to an elevated portion 16, the elevated portion 16 may abut the coloring instrument, thus applying a force against movement on the obstructed portion. The elevated portions 16 may also have a particular height so that a user may have difficulty overstepping the elevated portions 16 to color outside the lines that define the image. The elevated portions 16 may be made of any suitable material, such as, for example, paper, cardboard, velvet, plastic, Teflon, felt or Velcro.

The elevated portions 16 may be any suitable color. In some embodiments, the elevated portions may be a dark color, such as black, navy blue, dark gray, or any other suitable dark color. The dark color may advantageously allow a user to accidentally color the elevated portion with a coloring instrument without creating a visible mark. In some embodiments, the elevated portion may be a light color, or the same color as clear (e.g., unobstructed) spaces 18. Such an embodiment may allow a user to color elevated portions 16 as well as the clear spaces. In some embodiments, the elevated portions 16 may be a combination of dark colors, light colors, or dark and light colors. In some embodiments, the elevated portions may include a pattern or a printed image or text.

The elevated portions 16 may be attached to the base sheet 10 by any suitable method. For example, elevated portions 16 may be permanently fixed to the base sheet 10. Accordingly, elevated portions 16 may be coated with any suitable permanent bonding material such as, for example, glue or tape, or bonded to the base sheet 10 in any way such as by heat treatment, sewing, ultrasonic bonding, or any other suitable permanent type of bonding.

Alternatively, one or more elevated portions 16 may be removably attached to the base sheet 10. In this regard, at least a portion of the elevated portions 16 may be coated with any suitable permanent or temporary binding material such as, for example, glue, tape, static cling, magnetic attraction, snaps, Velcro, or any other suitable detachable mechanism. Such permanent or temporary binding materials may be located entirely on the elevated portions 16, entirely on the base sheet 10, or on both the elevated portions 16 and the base sheet 10.

In still other exemplary embodiments of the present invention, the elevated portions 16 may include one or more male connectors (not shown) and base sheet 10 may include one or more female connectors (not shown) such that the male connector of the elevated portions 16 may be inserted into and removed from (or permanently attached to) the female connector of the base sheet 10.

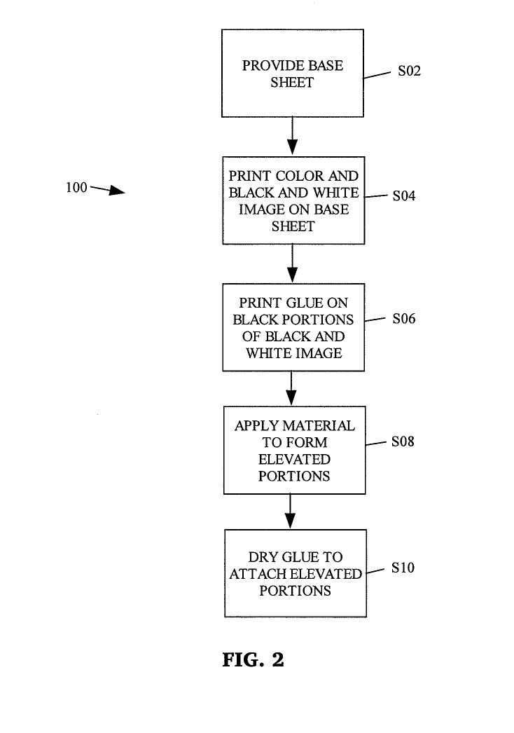

FIG. 2 is a flowchart, generally designated by reference number 100, showing a method of making the colored-image poster according to an exemplary embodiment of the present invention. In step S02 of the method 100, a base sheet is provided, which may be made of any suitable materials, such as, for example, paper or paper board. In step S04 of the method 100, the base sheet is printed with the image using a conventional 4-color (Cyan, Magenta, Yellow, Black) print process. In this step, the full color photographic image, as well as the black and white image to which the elevated portions are attached, are printed.

In step S06 of the method 100, a silk screen printing process is used to print a glue onto the color image already formed on the base sheet. In this step, the silk screen process is used to attach the glue to the black portions of the black and white image formed in step S04. The glue applied to the base sheet is preferably colored black. However, it should be appreciated that in other embodiments of the present invention in which the elevated portions are not black, another color glue can be used to match that of the elevated portions.

In step S08, the material used to form the elevated portions, such as, for example, short acrylic flocking, is applied to the entire base sheet. In step S10, an electrostatic charge is applied to the base sheet and the flocking, which causes the flocking to stand straight up from the base sheet.

In step S12, the base sheet is heated to dry the glue, thereby attaching the flocking to the base sheet. Thus, the flocking will only attach to the black areas of the black and white image previously formed on the base sheet. After drying of the glue, the unattached flocking can be removed from the base sheet by, for example, vacuuming, thereby forming the finished colored-image poster according to an exemplary embodiment of the present invention.

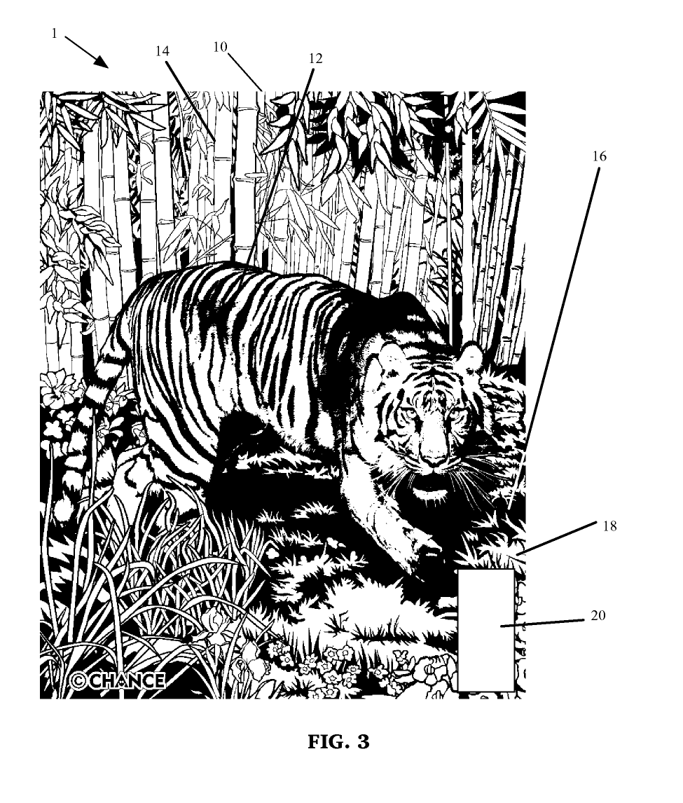

It should be appreciated that in various exemplary embodiments, the colored-image poster of the present invention may include additional elements, such as, for example, a coloring instrument holder, a musical system and a light system. As shown in FIG. 3, the additional element 20 may be permanently or removably attached to the colored-image poster 1 at, for example, the back or front of the base sheet 10. An attached musical and/or light system may include conventional circuitry, such as detector, sound and/or light circuitry so as to generate light and/or sound. For example, such circuitry may be configured so as to generate light and/or sound when a particular action by a user relative to the colored-image posted is detected, such as, for example, when a user applies pressure to the colored-image poster using a coloring instrument, when a user moves the colored-image poster, or when a user actuates a button located on the colored-image poster. The sound generated buy the additional element 20 may be music or a speaking voice, for example.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims and not by the foregoing specification.

What is claimed is:

1. A colored-image sheet comprising:
at least one surface comprising:
a first image comprising at least one color photographic image; and
a second image having boundaries defined by elevated portions on the at least one surface, the second image being capable of receiving colored media.

2. The colored-image sheet of claim 1, wherein the elevated portions are made of velvet, plastic or paper.

3. The colored-image sheet of claim 1, wherein the sheet is a poster.

4. The colored-image sheet of claim 1, wherein the sheet is a page of a book.

5. The colored-image sheet of claim 1, wherein the second image is non-permeable to the colored media.

6. The colored-image sheet of claim 1, wherein the first and second images form portions of the same image.

7. The colored-image sheet of claim 1, wherein the colored-image sheet further comprises a mechanism for producing at least one of sound and light.

8. The colored-image sheet of claim 7, wherein the mechanism produces music.

9. The colored-image sheet of claim 7, further comprising a coloring instrument holder attached to a portion of the colored-image sheet.

10. A method of making a colored-image sheet comprising the steps of:
printing a color image on a base sheet, the color image comprising at least one full color photographic image and at least one black and white image; and
attaching elevated portions to first portions of the at least one black and white image to define second portions within the at least one black and white image to be colored in.

11. The method of claim 10, wherein the step of attaching comprises printing glue onto the first portions of the at least one black and white image.

12. The method of claim 11, wherein the step of printing glue comprises a silk screen printing process.

13. The method of claim 10, wherein the step of attaching comprises attaching flock to the first portions of the at least one black and white image.

14. The method of claim 13, further comprising the step of applying an electrostatic charge to at least one of the base sheet and the flock so as to force the flock to stand vertically on the base sheet.
